(19) United States
(12) Patent Application Publication
(10) Pub. No.: US 2014/0209567 A1
(43) Pub. Date: Jul. 31, 2014

(54) TEMPLATE, MANUFACTURING METHOD OF THE TEMPLATE, AND STRAIN MEASURING METHOD IN THE TEMPLATE

(71) Applicant: KABUSHIKI KAISHA TOSHIBA, Tokyo (JP)

(72) Inventors: Hidenori SATO, Kanagawa (JP); Yuji KOBAYASHI, Mie (JP)

(21) Appl. No.: 13/920,268

(22) Filed: Jun. 18, 2013

Related U.S. Application Data
(60) Provisional application No. 61/757,820, filed on Jan. 29, 2013.

(51) Int. Cl. B29C 59/00; B29C 59/02

(52) U.S. Cl. CPC B29C 59/002; B29C 59/026
USPC 216/84; 425/385; 216/94

(57) ABSTRACT

According to one embodiment, provided is a template including a first pattern that is to be transferred to a processing target and is arranged on a transfer region defined on a first principal surface of a template substrate. The template includes a second pattern that is used to measure a position and arranged on a second principal surface of the template substrate opposite to the first principal surface.

### CROSS-REFERENCE TO RELATED APPLICATIONS

This application is based upon and claims the benefit of priority from U.S. Provisional Application No. 61/757,820, filed on Jan. 29, 2013; the entire contents of which are incorporated herein by reference.

### FIELD

Embodiments described herein relate generally to a template, a manufacturing method of a template, and a strain measuring method in the template.

### BACKGROUND

In a technique of manufacturing a semiconductor device including various kinds of many semiconductor elements such as transistors, a pattern scaling technique for increasing a degree of integration has been used. For further scaling, various kinds of lithography techniques have been developed. As one of the lithography techniques, there is a nanoimprint lithography which is a contact-type patterning technique of pressing a template in which a concave-convex pattern is formed into a wafer coated with resin or the like and forming a pattern on a wafer.

A photomask for the optical lithography according to the related art is manufactured to be four times as large as a wafer pattern, whereas a template for the nanoimprint lithography is contacted to a wafer for transferring and thus manufactured into a pattern of the same size as a wafer pattern. For this reason, positional deviation of a pattern of a template directly leads to misalignment of a wafer.

Further, positional deviation of a pattern of a template occurs due to (1) a strain caused in a process of manufacturing a template, (2) thermal deformation caused when ultraviolet (UV) light illuminates in a transfer process, (3) deformation by a strain correction function of a transfer device, or the like.

In this regard, it is necessary to measure and manages a positional deviation amount (strain) of a pattern of a template occurred in each process with a high degree of accuracy. In the related art, a pattern used to measure the positional deviation (strain) is formed on the surface at the side to which a template is transferred. In the case the measurement pattern is arranged, in a device with a high degree of integration in a chip such as memory devices, when the measurement pattern is transferred to the wafer, a problem occurs in a device operation. For this reason, the measurement pattern is arranged in a region (kerf) outside a chip. Under this condition, there is a problem in that it is difficult to measure the position in a chip, the number of measurement patterns arranged in a template is restricted, and it is difficult to perform multi-point measurement.

When it is difficult to arrange a measurement pattern in a chip, there is a method of directly measuring a device pattern formed in a chip. However, when a device pattern has the size exceeding an optically recognizable limit as in an NAND flash memory, there is a problem in that it is difficult to perform direct measurement.

### BRIEF DESCRIPTION OF THE DRAWINGS

FIGS. 1A to 1C are diagrams schematically illustrating an example of a structure of a nanoimprint template according to an embodiment.

FIG. 2 is a flowchart illustrating an example of a strain correcting process procedure when a template is manufactured according to an embodiment.

FIGS. 3A to 3H are cross-sectional views schematically illustrating an example of a process of a template manufacturing method according to an embodiment.

FIGS. 4A and 4B are diagrams schematically illustrating a state of a back surface when a template is manufactured.

FIG. 5 is a diagram illustrating an example of strain information.

FIG. 6 is a diagram illustrating an example of a strain amount correcting method.

FIG. 7 is a flowchart illustrating an example of a strain correcting process procedure when a template is used.

FIGS. 8A and 8B are diagrams schematically illustrating an example of a strain measurement pattern arrangement method of a template.

FIG. 9 is a diagram illustrating an example of a strain measurement pattern arrangement method of a template.

FIGS. 10A and 10B are diagrams illustrating another configuration example of a template according to an embodiment.

### DETAILED DESCRIPTION

In general, according to one embodiment, provided is a template including a first pattern that is to be transferred to a processing target and is arranged on a transfer region defined on a first principal surface of a template substrate. The template includes a second pattern that is used to measure a position and arranged on a second principal surface of the template substrate opposite to the first principal surface.

Hereinafter, a template, a manufacturing method of the template, and a strain measuring method in the template according to an embodiment will be described in detail with reference to the accompanying drawings. However, the present invention is not limited to the following embodiment.

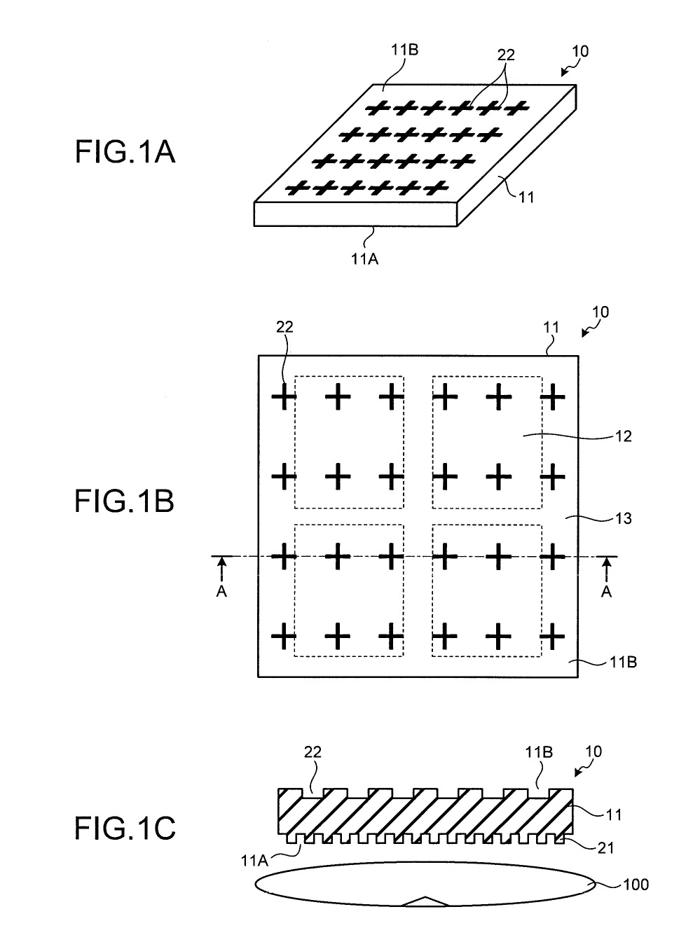

FIGS. 1A to 1C are diagrams schematically illustrating an example of a structure of a nanoimprint template according to an embodiment. FIG. 1A is a perspective view schematically illustrating the whole nanoimprint template, FIG. 1B is a plane view of the back surface of FIG. 1A, and FIG. 1C is a cross-sectional view taken along line A-A of FIG. 1B.

A template 10 is configured with a template substrate 11 made of quartz or the like. A plurality of transfer regions 12 are formed at a front surface 11A side (the surface at the side facing a processing target 100) of the template substrate 11. For example, the transfer region 12 is a region corresponding to a chip and a region in which a device pattern 21 used to form a device is arranged. The device pattern 21 is not limited in size and may have an optically recognizable size or an optically unrecognizable size. In this example, a line-and-space pattern having a half pitch of 50 nm is formed as the device pattern 21. Further, a non-transfer region called a kerf 13 removed by a dicing process is formed surrounding the transfer region 12.

A plurality of strain measurement patterns 22 used to measure positional deviation (strain) are formed at a back surface 11B (the surface opposite to the surface on which the device pattern 21 is formed) side of the template substrate 11. In this example, the strain measurement patterns 22 are evenly formed on the back surface 11B side of the template substrate 11. For this reason, the strain measurement pattern 22 can be arranged on any region whether the region on which the strain measurement pattern 22 is formed is the transfer region 12 or the kerf 13. Further, when the strain measurement pattern 22 is arranged on the region corresponding to the transfer region 12, the strain measurement pattern 22 can be arranged not to overlap the device pattern 21 at the front surface 11A side.

The strain measurement pattern 22 has a concave shape carved into the template substrate 11. For example, the strain measurement pattern 22 has a cross shape and has the size of 80 nm or more that can be measured (optically recognized) by a pattern position inspection device. In this example, as the strain measurement pattern 22, illustrated is a cross pattern in which two patterns that are 1 μm in length and 300 nm in width and has a rectangular shape change its direction at 90° in a plane of the template substrate 11 and are intersected with each other near the center of each other.

In the template 10, since the strain measurement pattern 22 is formed at the back surface 11B on which the device pattern 21 is not arranged, the strain measurement patterns 22 can be arranged at arbitrary positions at arbitrary intervals. Consequently, positional deviation measurement can be performed at more positions than in the related art without affecting an operation of a device formed using the template 10.

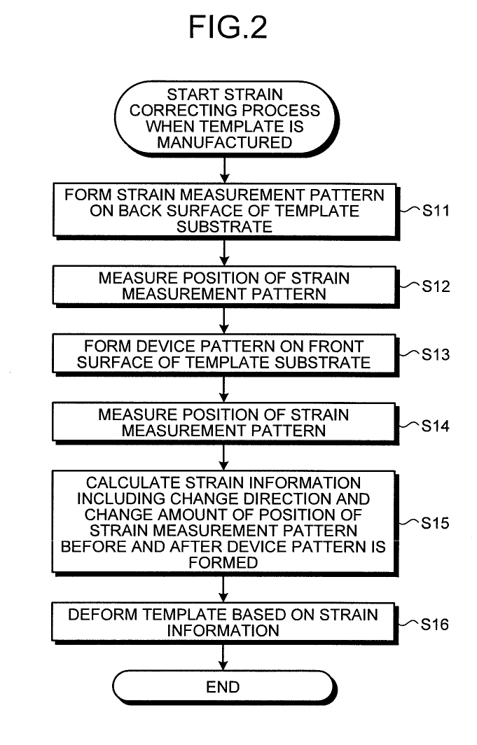

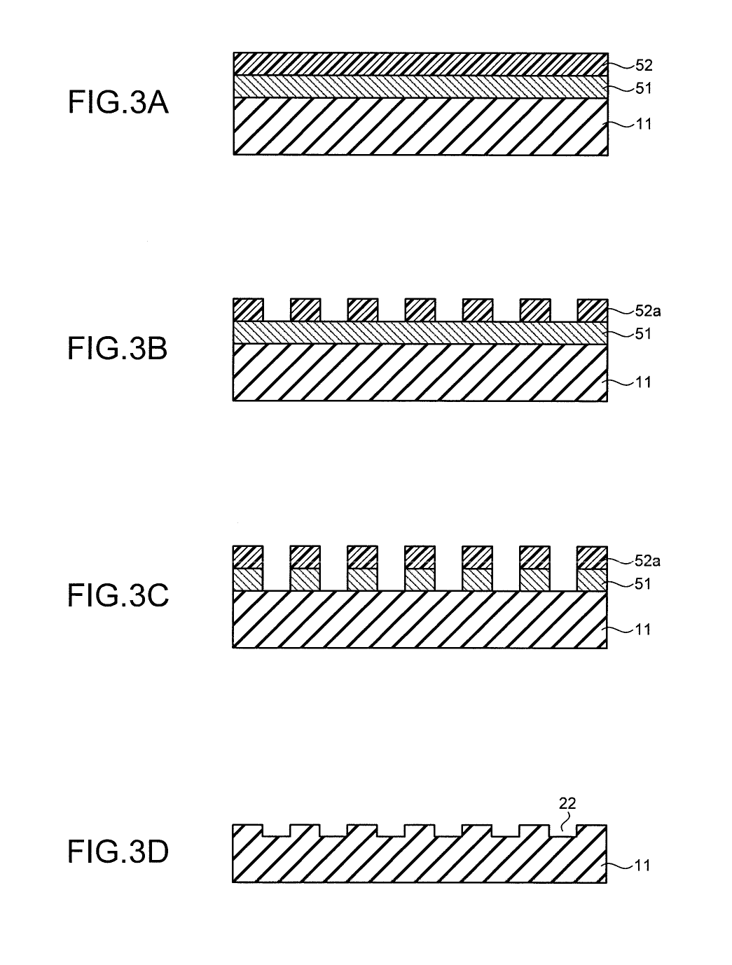

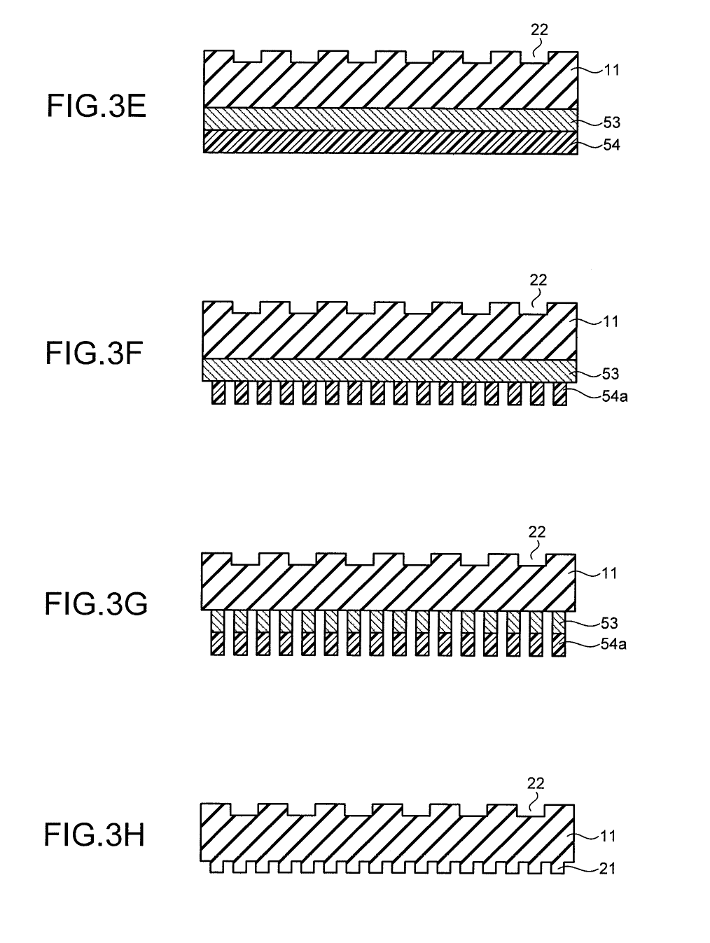

Next, a template manufacturing method will be described. FIG. 2 is a flowchart illustrating an example of a strain correcting process procedure when a template is manufactured according to an embodiment. FIGS. 3A to 3H are cross-sectional views schematically illustrating an example of a process of a template manufacturing method according to an embodiment. FIGS. 4A and 4B are diagrams schematically illustrating a state of a back surface when a template is manufactured. FIG. 4A is a plane view viewed from the back surface of the template substrate when the strain measurement pattern is formed on the back surface of the template substrate, and FIG. 4B is a plane view viewed from the back surface of the template substrate when the device pattern is formed on the front surface of the template substrate.

First of all, the strain measurement pattern 22 is formed on the back surface 11B of the template substrate 11 (the surface opposite to the front surface 11A on which the transfer pattern is formed) (step S11). Specifically, a mask layer 51 and an electron beam lithography resist 52 are formed on the back surface 11B of the template substrate 11 as illustrated in FIG. 3A. For example, a quartz substrate can be used as the template substrate 11, a Cr layer formed at the thickness of 20 nm by a method such as the sputtering technique can be used as the mask layer 51. Further, the electron beam lithography resist 52 can be formed at the thickness of 30 nm by a method such as the spin coating technique.

Then, a resist pattern 52a used to form the strain measurement pattern 22 is formed by lithographic exposure and development using an electron beam lithography device as illustrated in FIG. 3B. Here, the resist pattern 52a is formed to open a region on which the strain measurement pattern 22 is to be formed. A pattern in which two rectangular patterns having the width of 300 nm and the length of 1 μm are crossed in the form of a cross near the center can be formed as the strain measurement pattern 22. Further, the strain measurement pattern 22 can be formed at an arbitrary position without affecting the position of the device pattern 21 which will be formed on the front surface 11A of the template substrate 11 later.

Thereafter, the mask layer 51 is etched by dry etching using the resist pattern 52a as a mask, and thus the strain measurement pattern 22 is transferred to the mask layer 51 as illustrated in FIG. 3C. Then, the template substrate 11 is etched up to a predetermined depth by dry etching using the patterned mask layer 51 as a mask as illustrated in FIGS. 3D and 4A. For example, the etching depth may be 30 nm. As a result, the strain measurement pattern 22 with the cross-shaped concave structure in which two rectangular patterns having the width of 300 nm, the length of 1 μm, and the depth of 30 nm are crossed at 90° is formed on the back surface 11B of the template substrate 11.

Then, the position of the strain measurement pattern 22 formed on the back surface 11B of the template substrate 11 is measured using a pattern position measuring device (step S12). The pattern position measuring device measures the position of a pattern using light having a wavelength of 193 nm. For example, position measurement is performed on each of the strain measurement patterns 22 formed on the back surface 11B of the template substrate 11 as illustrated in FIG. 4A. At this time, for example, an original point of two-dimensional orthogonal coordinates is set on the back surface 11B of the template substrate 11, and the position is measured based on the original point. For example, in the example of FIG. 4A, a bottom left-hand corner of the template substrate 11 is used as the original point, and processing of obtaining distances of each strain measurement pattern 22 in an X axis direction and a Y axis direction.

Thereafter, the device pattern 21 is formed on the front surface 11A of the template substrate 11 (step S13). Specifically, a mask layer 53 and an electron beam lithography resist 54 are formed on the front surface 11A of the template substrate 11 as illustrated in FIG. 3E. For example, a Cr layer formed at the thickness of 20 nm by a method such as the sputtering technique may be used as the mask layer 53. Further, the electron beam lithography resist 54 may be formed at the thickness of 30 nm by a method such as the spin coating technique.

Then, a resist pattern 54a used to form the device pattern 21 is formed by lithographic exposure and development using the electron beam lithography device as illustrated in FIG. 3F. Here, the resist pattern 54a is formed to open a region on which the device pattern 21 is to be formed. A line-and-space pattern having the width of 50 nm may be formed as the device pattern 21.

Thereafter, the mask layer 53 is etched by dry etching using the resist pattern 54a as a mask, and the device pattern 21 is transferred to the mask layer 53, as illustrated in FIG. 3G. Then, the template substrate 11 is etched up to a predetermined depth by dry etching using the patterned mask layer 53 as a mask as illustrated in FIG. 3H.

For example, the etching depth may be 30 nm. Thus, the device pattern 21 including the line-and-space pattern having the width of 50 nm and the depth of 30 nm is formed. As a result, the template 10 in which the device pattern 21 and the strain measurement pattern 22 are formed is completed.

In the processing process of the front surface 11A of the template substrate 11, positional deviation of the strain measurement pattern 22 of the back surface 11B occurs due to distribution of heat applied to the template substrate 11 when the device pattern 21 is formed as illustrated in FIG. 4B.

Then, the position of the strain measurement pattern 22 formed on the front surface 11A of the template substrate 11 is measured using the pattern position measuring device (step S14). The pattern position measuring device measures the position of a pattern using light having a wavelength of 193 nm. For example, position measurement is performed on each of the strain measurement patterns 22 formed on the back surface 11B of the template substrate 11 as illustrated in FIG. 4B. This process is similar to the process of step S12.

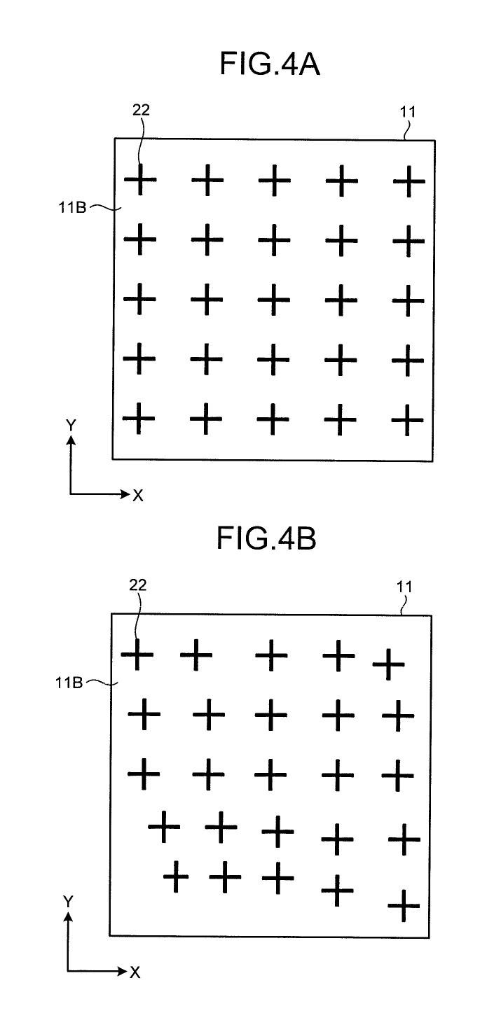

Thereafter, strain information including a change direction and a change amount of the position of the strain measurement pattern 22 before and after the device pattern 21 is formed is calculated (step S15). In other words, positional deviation of the position after the device pattern 21 is formed with respect to the position before the device pattern 21 is formed is calculated as a vector. This is obtained by calculating the positional deviation amount and the direction of the position of each device pattern 21 based on FIGS. 4A and 4B. FIG. 5 is a diagram illustrating an example of the strain information. In FIG. 5, a start point of an arrow is the position of the strain measurement pattern 22 before the device pattern 21 is formed, an end point of the arrow is the position of the strain measurement pattern 22 after the device pattern 21 is formed, a direction of the arrow represents a strain (positional deviation) direction, and the length of the arrow represents a strain (positional deviation) amount.

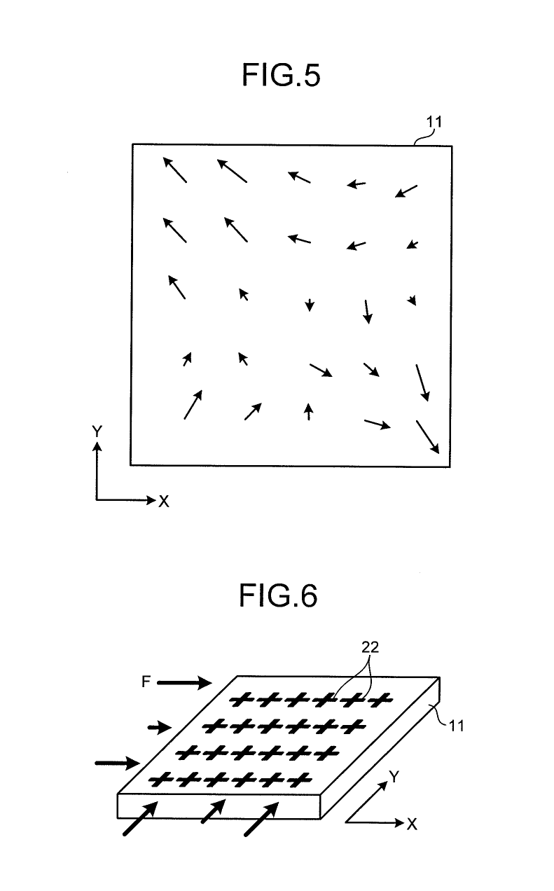

Then, a pattern is transferred to a processing target including a wafer or a daughter template using the manufactured template 10. However, at this time, the template 10 is deformed by adjusting force applied to the side of the template 10 according to the position based on the strain information in order to solve the strain of the template 10 (step S16). FIG. 6 is a diagram illustrating an example of a strain amount correcting method. As illustrated in FIG. 6, the strain information (a strain amount counter value) of FIG. 5 is input to a nanoimprint transfer device, and the template 10 is deformed according to a counter. In other words, force F is applied to the side of the template 10 to negate the strain information illustrated in FIG. 5.

Then, the deformed template 10 is used to manufacture a semiconductor device or a daughter template. Specifically, a processing target which is a wafer on which a semiconductor device is manufactured or a daughter template is coated with hardening resin (an imprint material) hardened by light (UV light or the like) or heat, the surface of the template 10 on which the device pattern 21 is formed is positioned to face the processing target, the template 10 is pressed into the processing target while being irradiated with light or applying heat, and hardening resin is cured. Thereafter, the template 10 is removed and a process of processing (etching) the processing target is performed using the cured hardening resin as a mask. As a result, the strain correcting process at the time of manufacturing of the template ends.

In FIG. 2, the strain correcting process at the time of manufacturing of the template 10 using the strain measurement pattern 22 formed on the back surface 11B of the template 10 has been described, but the embodiment is not limited to the example using the strain measurement pattern 22. For example, at the time of the imprint lithography, as UV light illuminates or heat is applied, the template 10 is thermally deformed, or the template 10 is deformed by application of force by the nanoimprint transfer device as described above. In this regard, information of strain occurred when the imprint lithography process is performed is obtained, and the imprint lithography process can be performed to negate the strain information.

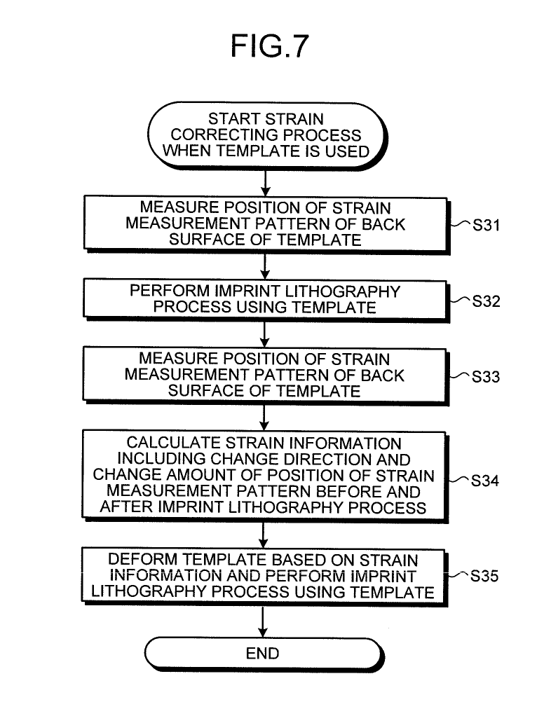

FIG. 7 is a flowchart illustrating an example of a strain correcting process procedure when a template is used. First of all, the position of the strain measurement pattern 22 formed on the back surface of the template 10 is measured using the pattern position measuring device (step S31). The pattern position measuring device measures the position of a pattern using light having a wavelength of 193 nm. For example, position measurement is performed on each of the strain measurement patterns 22 formed on the back surface 11B of the template substrate 11 as illustrated in FIG. 4A.

Then, the imprint lithography process using the template 10 is performed (step S32). Specifically, the lithography process is executed on a wafer through the nanoimprint transfer device, and a predetermined number (for example, 50) of wafers are processed.

Thereafter, the position of the strain measurement pattern 22 formed on the back surface of the template 10 is measured using the pattern position measuring device (step S33). The pattern position measuring device measures the position of a pattern using light having a wavelength of 193 nm. For example, position measurement is performed on each of the strain measurement patterns 22 formed on the back surface 11B of the template substrate 11 as illustrated in FIG. 4B.

Then, strain information including a change direction and a change amount of the position of the strain measurement pattern 22 before and after the imprint lithography process is performed is calculated (step S34). In other words, positional deviation of the position of the strain measurement pattern 22 after the imprint lithography is performed with respect to the position of the strain measurement pattern 22 before the imprint lithography is performed is calculated as a vector. This is obtained as in FIG. 5 by calculating the positional deviation amount and the direction of the position of each device pattern 21 based on FIGS. 4A and 4B.

Then, the template 10 is deformed by adjusting force applied to the side of the template 10 based on the strain information in order to solve the strain of the template 10, and the imprint lithography process using the template 10 is performed (step S35). In other words, the strain information is feed-forwarded to the correction function of the nanoimprint transfer device, and the subsequent imprint lithography process is executed. At this time, the correction of the template 10 is performed by changing the strength of force applied to the side of the template 10 according to the strain amount (direction) of each position of the template 10 as illustrated in FIG. 6. Then, the strain correcting process when the template is used ends.

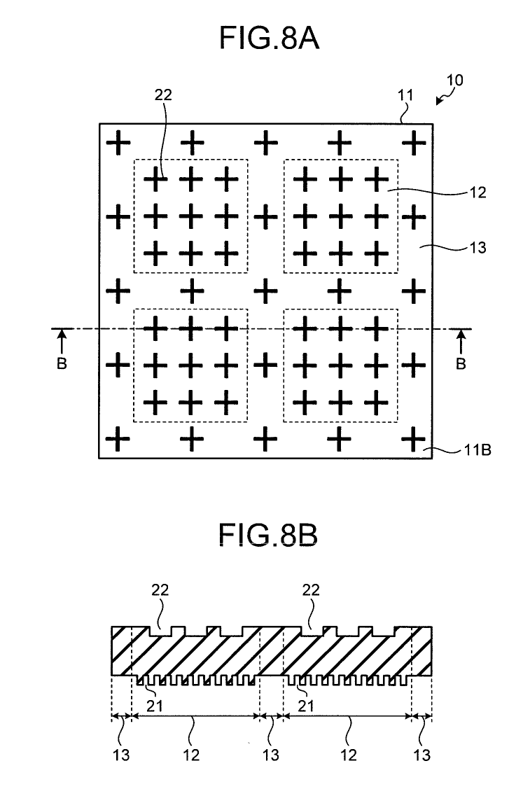

The above description has been made in connection with the example in which the strain measurement patterns 22 are evenly arranged on the back surface 11B of the template substrate 11, but the embodiment is not limited to this example. FIGS. 8A and 8B are diagrams schematically illustrating an example of a strain measurement pattern arrangement method of a template, FIG. 8A is a plane view illustrating a back surface side of a template, and FIG. 8B is a cross-sectional view taken along line B-B of FIG. 8A. As illustrated in FIGS. 8A and 8B, the density of the strain measurement patterns 22 may be high in the region corresponding to the transfer region 12 on which the device patterns 21 are formed, whereas the density of the strain measurement patterns 22 may be low in the region corresponding to the kerf 13 on which the device patterns 21 are not formed. For example, when the device pattern 21 is the line-and-space pattern and the template 10 has the positional deviation, this lowers the manufacturing yield of the semiconductor device. Thus, it is preferably to detect the positional deviation of the region on which the device pattern 21 is formed with a high degree of accuracy and deform the template 10 based on the detected positional deviation. For this reason, as illustrated in FIGS. 8A and 8B, it is effective to cause the region on which the device pattern 21 is formed to differ in the density of the strain measurement pattern 22 from the region on which the device pattern is not formed.

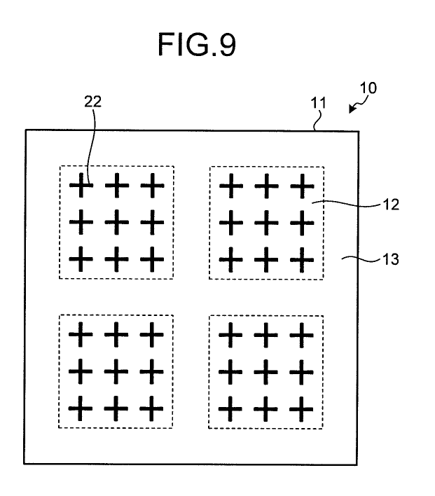

FIG. 9 is a diagram illustrating an example of a strain measurement pattern arrangement method of a template and a plane view illustrating a back surface side of a template. In the example of FIG. 9, the strain measurement pattern 22 is not arranged on the region corresponding to the kerf 13, and the strain measurement pattern 22 is arranged only on the region corresponding to the transfer region 12. This arrangement is based on the concept that it is unnecessary to specially consider the positional deviation of the region corresponding to the kerf 13, and the imprint lithography process is executed based on the strain information of the transfer region 12.

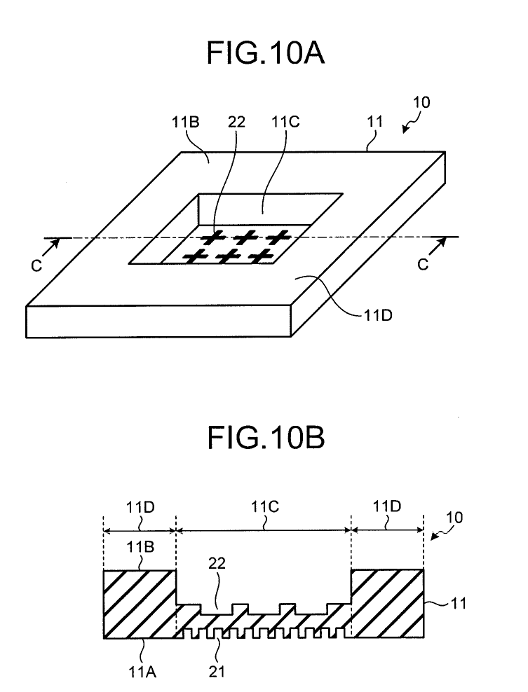

The above description has been made in connection with the example in which the template 10 has a plate-like structure, but the embodiment is not limited to this example. FIGS. 10A and 10B are diagrams illustrating another configuration example of a template according to an embodiment. FIG. 10A is a perspective view illustrating a template, and FIG. 10B is a cross-sectional view taken along line C-C of FIG. 10A. As illustrated in FIGS. 10A and 10B, a region 11C of the back surface corresponding to the transfer region 12 of the template substrate 11 may be recessed downward and have a thinner structure than another region 11D (the region corresponding to the kerf 13). In this case, the device pattern 21 is formed on the thin region 11C, the strain measurement pattern 22 is formed on the region 11C, and the strain measurement pattern 22 is not formed on the thick region 11D. Since the thin region 11C on which the strain measurement pattern 22 is formed is likely to have strain, the strain measurement pattern 22 is arranged on the region 11C, and thus the correction can be accurately performed.

Further, the above description has been made in connection with the example in which the line-and-space pattern is formed as the device pattern 21, but the embodiment is not limited to this example. For example, a contact hole pattern connected to each line pattern of the line-and-space pattern arranged on a layer above or below the processing target may be formed as the device pattern 21.

In the present embodiment, the strain measurement pattern 22 is arranged on the back surface side rather than the front surface side of the template 10 on which the device pattern 21 is formed. Consequently, the strain measurement pattern 22 can be arranged even on the region on which the device pattern 21 is formed regardless of the device pattern 21 without affecting an operation of a semiconductor device formed by transferring the device pattern 21. Further, since many strain measurement patterns 22 can be arranged on the template 10, there is an effect by which by measuring the positional deviation of the strain measurement pattern 22, it is possible to precisely deform the template 10 and perform the nanoimprint lithography process based on the information of the positional deviation.

Further, after the strain measurement pattern 22 is formed, the device pattern 21 is formed at the front surface 11A side of the template substrate 11, and the strain information obtained by the position measurement of the strain measurement pattern 22 before and after the device pattern 21 is formed is acquired. Then, in order to solve the strain information, the template 10 is corrected, and the imprint lithography process is performed. In other words, even when the positional deviation occurs in the device pattern 21 due to influence of thermal distribution received when the device pattern 21 is formed on the template substrate 11, in order to solve the strain information, the template 10 is corrected, and the imprint lithography process is performed. Thus, there is an effect by which the positional deviation of the transferred pattern can be suppressed.

Furthermore, the strain information obtained from the position measurement of the strain measurement pattern 22 before and after the imprint process is acquired, and in order to solve the strain information, the template 10 is corrected, and the imprint lithography process is performed. In other words, even when the positional deviation occurs in the device pattern 21 due to influence of thermal deformation when UV light illuminates or heat is applied in the imprint lithography process or influence of deformation by the strain correction function of the nanoimprint transfer device, in order to solve the strain information, the template 10 is corrected, and the imprint lithography process is performed. Thus, there is an effect by which the positional deviation of the transferred pattern can be suppressed.

In addition, as the strain measurement pattern 22 is formed in the template 10 for forming the line-and-space pattern and the template 10 for forming the contact hole pattern, position management can be performed in both the line-and-space pattern and the contact hole pattern. Consequently, there is an effect by which even when both patterns are fine patterns, both patterns can overlap each other with a high degree of accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template, comprising:
a first pattern that is to be transferred to a processing target and is arranged on a transfer region defined on a first principal surface of a template substrate; and
a second pattern that is used to measure a position and arranged on a second principal surface of the template substrate opposite to the first principal surface.

2. The template according to claim 1, wherein the second patterns are evenly arranged on the second principal surface.

3. The template according to claim 1, wherein
the first principal surface of the template substrate includes a transfer region and a non-transfer region surrounding the transfer region, and
the second pattern is arranged only on a region on the second principal surface corresponding to the transfer region.

4. The template according to claim 1, wherein the first principal surface of the template substrate includes the transfer region and a non-transfer region surrounding the transfer region, and
a density of the second pattern arranged on a region on the second principal surface corresponding to the transfer region is higher than a density of the second pattern arranged on a region on the second principal surface corresponding to the non-transfer region.

5. The template according to claim 4, wherein the first pattern is a line-and-space pattern or a contact hole pattern used to form a contact hole connected to each line pattern that is formed by the line-and-space pattern.

6. The template according to claim 3, wherein a region of the second principal surface corresponding to the transfer region has a concave portion that is formed at a depth not to penetrate the template substrate.

7. The template according to claim 1, wherein the second pattern has an optically recognizable size.

8. The template according to claim 7, wherein the second pattern has a size of 80 nm or more.

9. The template according to claim 1, wherein the second pattern has a cross shape.

10. A manufacturing method of a template, comprising:
forming a first pattern used to measure a position on a first principal surface of a template substrate; and
forming a second pattern to be transferred to a processing target on a second principal surface opposite to the first principal surface of the template substrate.

11. The manufacturing method of the template according to claim 10, wherein
the forming of the first pattern includes
coating the first principal surface of the template substrate with a first resist,
drawing the first pattern on the first resist using an electron beam to form the first resist pattern, and
etching the first principal surface of the template substrate using the first resist pattern as a mask to form the first pattern, and
the forming of the second pattern includes
coating the second principal surface of the template substrate with a second resist,
drawing the second pattern on the second resist using an electron beam to form a second resist pattern, and
etching the second principal surface of the template substrate using the second resist pattern as a mask to forme the second pattern.

12. The manufacturing method of the template according to claim 10, further comprising:
measuring a first position of the first pattern within the template substrate before the second pattern is formed and after the first pattern is formed;
measuring a second position of the first pattern within the template substrate after the second pattern is formed; and
measuring positional deviation of each first pattern using the second position and the first position.

13. The manufacturing method of the template according to claim 10, wherein
the forming of the first pattern includes evenly arranging the first patterns on the first principal surface.

14. The manufacturing method of the template according to claim 10, wherein
the forming of the second pattern includes forming the second pattern to include a transfer region on which the second pattern is arranged and a non-transfer region surrounding the transfer region, and
the forming of the first pattern includes arranging the first pattern only on a region on the first principal surface corresponding to the transfer region and the first pattern not to be arranged on a region on the first principal surface corresponding to the non-transfer region.

15. The manufacturing method of the template according to claim 10, wherein
the forming of the second pattern includes forming the second pattern to include a transfer region on which the second pattern is arranged and a non-transfer region surrounding the transfer region, and
the formation of the first pattern includes forming the first pattern such that the density of the first pattern arranged on a region on the first principal surface corresponding to the transfer region is higher than the density of the first pattern arranged on a region on the first principal surface corresponding to the non-transfer region.

16. The manufacturing method of the template according to claim 15, wherein the second pattern is a line-and-space pattern or a contact hole pattern used to form a contact hole connected to each line pattern that is formed by the line-and-space pattern.

17. The manufacturing method of the template according to claim 10, wherein the first pattern has an optically recognizable size.

18. A strain measuring method in a template, the template including a transfer region in which a first pattern to be transferred to a processing target is arranged on a first principal surface and a second pattern that is used to measure a position and is arranged on a second principal surface opposite to the first principal surface, the method comprising:
measuring a first position of the second pattern within the second principal surface;
coating the processing target with an imprint material;
arranging the processing target coated with the imprint material and the first principal surface of the template to face each other;
pressing while causing the processing target to come into contact with the template, solidifying the imprint material, and transferring the first pattern to the processing target;
measuring a second position of the second pattern within the second principal surface after the transferring; and
measuring positional deviation of each second pattern based on the second position and the first position.

19. The strain measuring method according to claim 18, wherein the second position is measured after the coating of the imprint material and the transferring of the first pattern to the processing target are executed on a predetermined number of processing targets.

20. The strain measuring method according to claim 18, wherein
the imprint material is UV curable resin or thermoset resin, and
the transferring includes transferring the first pattern to the processing target by being irradiated with UV light to the imprint material or applying heat to the imprint material.
